(19) United States
(12) Patent Application Publication
(10) Pub. No.: US 2026/0155514 A1
(43) Pub. Date: Jun. 4, 2026

(54) BATTERY PACK WITH FLEXIBLE BUSBAR FRAME JOINT

(71) Applicant: Ford Global Technologies, LLC, Dearborn, MI (US)

(72) Inventors: Jie Deng, Novi, MI (US); Brian Utley, Canton, MI (US); Sangyeon Kim, Northville, MI (US); Mihir Devendra Upadhye, Ann Arbor, MI (US)

(21) Appl. No.: 18/966,517

(22) Filed: Dec. 3, 2024

(51) Int. Cl. H01M 50/242; H01M 10/04; H01M 50/262; H01M 50/507

(52) U.S. Cl. CPC H01M 50/242; H01M 10/0468; H01M 50/262; H01M 50/507

(57) ABSTRACT

A battery pack assembly includes a cell stack assembly including a plurality of battery cells disposed along a cell stack axis. A busbar frame is joined to the cell stack assembly. The busbar frame includes at least one relief notch that accommodates movement of the cell stack assembly relative to the frame. At least one joint can connect the busbar frame to the endplate. The at least one relief notch can be configured to accommodate movement of the at least one joint when the endplate is moved axially relative to the busbar frame.

### TECHNICAL FIELD

This disclosure relates generally to joints that connect components of a battery pack and, more particularly, to a joint that can be flexed.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack assembly, including: a cell stack assembly including a plurality of battery cells disposed along a cell stack axis; and a busbar frame joined to the cell stack assembly, the busbar frame including at least one relief notch that accommodates movement of the cell stack assembly.

In some aspects, the techniques described herein relate to a battery pack assembly, further including a battery pack enclosure providing an interior, the cell stack assembly and the busbar frame housed within the interior.

In some aspects, the techniques described herein relate to a battery pack assembly, wherein the busbar frame is a first busbar frame including at least one first relief notch, and further including a second busbar frame including at least one second relief notch that accommodates movement of the cell stack assembly, the first busbar frame on a first side of the cell stack assembly, the second busbar frame on an opposite, second side of the cell stack assembly.

In some aspects, the techniques described herein relate to a battery pack assembly, further including a first endplate and a second endplate of the cell stack assembly, the plurality of battery cells sandwiched between the first endplate and the second endplate along the cell stack axis, the busbar frame connected to both the first endplate and the second endplate.

In some aspects, the techniques described herein relate to a battery pack assembly, further including a battery pack enclosure that compresses together the cell stack assembly along the cell stack axis.

In some aspects, the techniques described herein relate to a battery pack assembly, further including an endplate of the cell stack assembly and at least one joint connecting the busbar frame to the endplate, the at least one relief notch configured to accommodate movement of the at least one joint when the endplate is moved axially relative to the busbar frame.

In some aspects, the techniques described herein relate to a battery pack assembly, wherein the at least one relief notch receives the at least one joint to accommodate axial movement of the endplate relative to the busbar frame.

In some aspects, the techniques described herein relate to a battery pack assembly, wherein the at least one relief notch permits movement of the at least one joint to accommodate axial movement of the endplate relative to the busbar frame.

In some aspects, the techniques described herein relate to a battery pack assembly, wherein the at least one relief notch opens laterally outward away from the cell stack assembly.

In some aspects, the techniques described herein relate to a battery pack assembly, wherein the at least one joint includes a mechanical fastener that engages an insert nut held in a housing.

In some aspects, the techniques described herein relate to a battery pack assembly, wherein the busbar frame includes the housing.

In some aspects, the techniques described herein relate to a battery pack assembly, wherein the mechanical fastener extends through an aperture in the endplate to threadably engage the insert nut held within the housing.

In some aspects, the techniques described herein relate to a battery pack assembly, further including a flange of the busbar frame, the flange projecting laterally outward away from the cell stack assembly, the flange providing the housing.

In some aspects, the techniques described herein relate to a battery pack assembly, wherein the endplate is a first endplate, the at least one joint is at least one first joint, and the at least one relief notch is at least one first relief notch, and further including a second endplate connected to the busbar frame through at least one second joint, and at least one second relief notch that accommodates movement of the at least one second joint when the second endplate is moved axially relative to the busbar frame.

In some aspects, the techniques described herein relate to a battery pack assembly, including: a cell stack assembly including a plurality of battery cells disposed along a cell stack axis between a first endplate and a second endplate; an enclosure assembly that compresses together the cell stack assembly along the cell stack axis; a busbar frame disposed alongside the cell stack assembly; at least one first joint connecting the busbar frame to the first endplate, the busbar frame including at least one first relief notch that permits movement of the at least one first joint when the first endplate is moved along the cell stack axis relative to the busbar frame; and at least one second joint connecting the busbar frame to the second endplate, the busbar frame including at least one second relief notch that permits movement of the at least one first joint when the second endplate is moved along the cell stack axis relative to the busbar frame.

In some aspects, the techniques described herein relate to a battery pack assembly, wherein the at least one first relief notch accommodates axial movement of the at least one first joint, wherein the at least one second relief notch accommodates axial movement of the at least one second joint.

In some aspects, the techniques described herein relate to a battery pack assembly, wherein the at least one first relief notch accommodates movement of the at least one first joint, wherein the at least one second relief notch accommodates movement of the at least one second joint.

In some aspects, the techniques described herein relate to a battery pack assembly, wherein the at least one first joint and the at least one second joint each include a cup-shaped receptacle holding an insert nut.

In some aspects, the techniques described herein relate to a battery pack assembly, wherein the at least one first relief notch and the at least one second relief notch both open outward away from the cell stack assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates an expanded view of the battery pack from FIG. 1.

FIG. 3 is a side view of a joint connecting a busbar frame to an endplate of the battery pack shown in FIG. 2 when the battery pack is assembled according to an exemplary aspect of the present disclosure.

FIG. 4 is a section view taken at line 4-4 in FIG. 3.

FIGS. 5A-5C show housings of joints according to other exemplary embodiments of the present disclosure that are variations of the housings shown in FIGS. 3 and 4.

FIG. 6 is a perspective view of a housing according to yet another exemplary embodiment of the present disclosure.

FIG. 7 is a section view of a joint utilizing the housing of FIG. 6.

FIGS. 8A-8C show housings of joints according to other exemplary embodiments of the present disclosure that are variations of the housings shown in FIGS. 6 and 7.

### DETAILED DESCRIPTION

This disclosure details exemplary battery pack assemblies having joints that connect components. Relief notches can be incorporated into components of the battery pack to facilitate and accommodate flexing of the joints. The joints can flex to accommodate movement of the components relative to each other, such as movement due to compression of a cell stack during assembly of the battery pack.

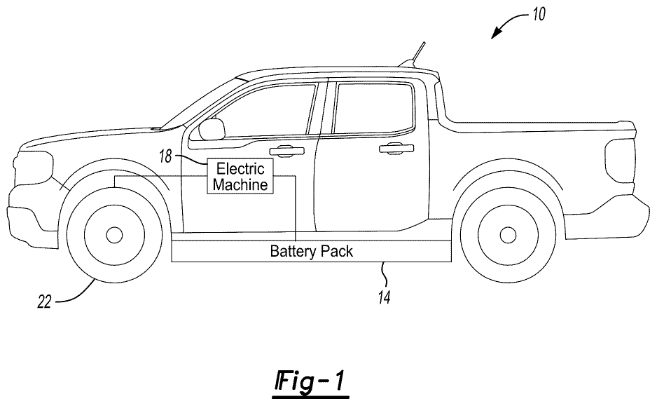

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

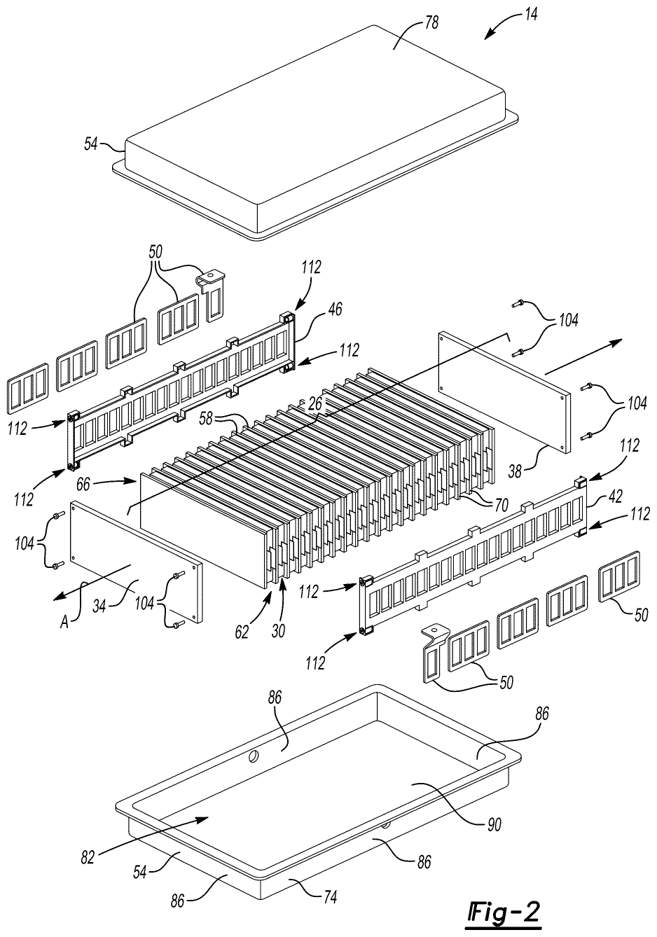

With reference now to FIG. 2, the traction battery pack 14 includes, in the exemplary embodiment, a cell stack assembly 26 having a cell stack 30, a first endplate 34, and a second endplate 38. The traction battery pack 14 further includes a first busbar frame 42, a second busbar frame 46, a plurality of busbars 50, and an enclosure assembly 54.

The cell stack 30 includes a plurality of individual battery cells 58 disposed along a cell stack axis A. The cell stack 30 is positioned between the first endplate 34 and the second endplate 38 along the cell stack axis A. The cell stack 30 can further include cell separators and foam.

In an embodiment, the battery cells 58 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

When assembled, the first busbar frame 42 is positioned on a first side 62 of the cell stack 30, and the second busbar frame 46 is positioned on an opposite, second side 66 of the cell stack 30. The busbars 50 are each secured to the first busbar frame 42 or the second busbar frame 46 via, for example, heat stakes.

The example battery cells 58 include terminals 70 that extend through an aperture in the first busbar frame 42 or an aperture in the second busbar frame 46 to connect directly to the busbars 50. The terminals 70 can connect to the busbars 50 via welds, for example.

The enclosure assembly 54 includes an enclosure tray 74 and an enclosure cover 78 that can be joined together to provide an interior 82. The cell stack assembly 26 along with the first busbar frame 42, the second busbar frame 46, and the busbars 50 are held within the interior 82.

In this example, the components of the battery pack 14 are immersion cooled. That is, a liquid coolant can be circulated through the interior 82 to manage thermal energy levels of those components. In this example, the liquid coolant takes on thermal energy from components within the interior 82 to cool those components, which are at least partially submerged within the liquid coolant. The liquid coolant could instead be used to heat the components.

In the exemplary embodiment, the tray 74 includes walls 86 that extend vertically upward from a floor 90. When the battery pack 14 is assembled with the cell stack assembly 26 in the interior 82, the walls 86 can compress together the cell stack 30, the first endplate 34, and the second endplate 38 along the cell stack axis A.

To prepare the example cell stack assembly 26 for installation, the first busbar frame 42 with its busbars 50 and the second busbar frame 46 with its busbars 50 are joined to the cell stack assembly 26. The first busbar frame 42 is joined at a first end to the first endplate 34, and at a second end to the second endplate 38. Similarly, the second busbar frame 46 is joined at a first end to the first endplate 34 at a second to the second endplate 38. The first busbar frame 42 and the second busbar frame 46 can be molded of a polymer-based material. In some examples, the cell stack 30 can be compressed along the cell stack axis A prior to joining the first busbar frame 42 and the second busbar frame 46 to the first endplate 34 and the second endplate 38.

The cell stack assembly 26 with the first endplate 34 and the second endplate 38 can then be compressed further along the cell stack axis A. Manufacturing tooling can apply an axially directed clamping force to the first endplate 34 and the second endplate 38 to compress the cell stack assembly 26 along the cell stack axis A. The compressing can decrease an overall axial length of the cell stack assembly 26, which can allow the cell stack assembly 26 to fit between the walls 86. Compressing the cell stack assembly 26 may not be required if the cell stack assembly 26 can fit within the tray 74 without further compression.

The cell stack assembly 26 with the first busbar frame 42 and the second busbar frame 46 are inserted into the tray 74 when the cell stack assembly 26 slightly compressed. The manufacturing tooling can apply the clamping force hold the cell stack assembly 26 in a compressed state as the cell stack assembly 26 with the first busbar frame 42 and the second busbar frame 46 are inserted into the tray 74.

After being positioned within the interior 82 between the walls 86, the manufacturing tooling can release the clamping force. The cell stack assembly 26 then expand slightly along the cell stack axis A against the walls 86.

The first busbar frame 42 connects to the first endplate 34 through a plurality of joints. Other joints also connect the first busbar frame 42 to the second endplate 38. Similarly styled joints connect the second busbar frame 46 to the first endplate 34, and the second busbar frame 46 to the second endplate 38.

As detailed below, the joints are configured to accommodate some movement of the first endplate 34 and the second endplate relative to the first busbar frame 42 and the second busbar frame 46. Permitting the joints to accommodate movement can, among other things, help to keep the joints secure during compression of the cell stack assembly 26 along the cell stack axis A prior to inserting the cell stack assembly 26 into the tray 74, and then during expansion of the cell stack assembly 26 against the walls 86.

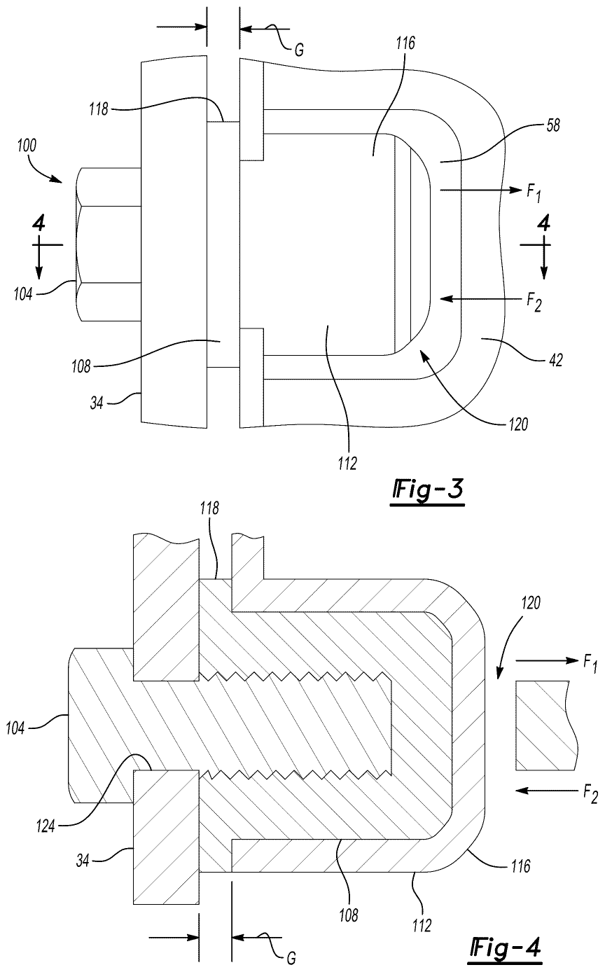

With reference now to FIGS. 3 and 4, and continuing reference to FIG. 2, an example joint 100 includes a mechanical fastener 104 threadably engaged with an insert nut 108 that is held within a housing 112. The example joint 100 shown in FIGS. 3-4 is utilized to connect the first busbar frame 42 to the first endplate 34. In this example, two joints 100 are used to connect the first busbar frame 42 to the first endplate 34.

Two joints mimicking the joint 100 connect the first busbar frame 42 to the second endplate 38. Two joints mimicking the joint 100 connect the second busbar frame 46 to the first endplate 34. Two joints mimicking the joint 100 connect the second busbar frame 46 to the second endplate 38.

In the exemplary embodiment, the housing 112 of the joint 100 provides a cup-shaped receptacle 116 that receives the insert nut 108. The housing 112 can be overmolded about the insert nut 108 to secure the insert nut 108 to the housing 112. A flange 118 of the insert nut 108 can maintain a gap G between the first endplate 34 and the busbar frame 42.

The first busbar frame 42 includes a relief notch 120 about the housing 112. Due to the relief notch 120 the housing 112 can flex in a direction F1 relative to other portions of the first busbar frame 46 when the cell stack assembly 26 is compressed during installation into the tray 74, and then flex back in a direction F2 when the cell stack assembly 28 expands along the cell stack axis A against the walls 86 of the tray 74. The example joint 100 moves axially further into the relief notch 120 when flexed in the direction F1.

The mechanical fastener 104 can threadably engage the insert nut 108 to secure the first busbar frame 42 to the first endplate 34. The mechanical fastener 104 extends through an aperture 124 in the first endplate 34 to engage the insert nut 108 of the joint 100. In this example, the relief notch 120 and the joint 100 are configured such that some axial movement is permitted, but movement in other directions is restricted. This can facilitate retention of the first busbar frame 42 to the first endplate 34 through the joint 100.

In this example, the housing 112 is part of the busbar frame 42 and the mechanical fastener 104 extends through the first endplate 34 to engage the insert nut 108 held by the housing 112. In other examples, the first endplate 34 could include the housing 112 holding the insert nut 108, and the mechanical fastener 104 could extend through an aperture in the busbar frame 42.

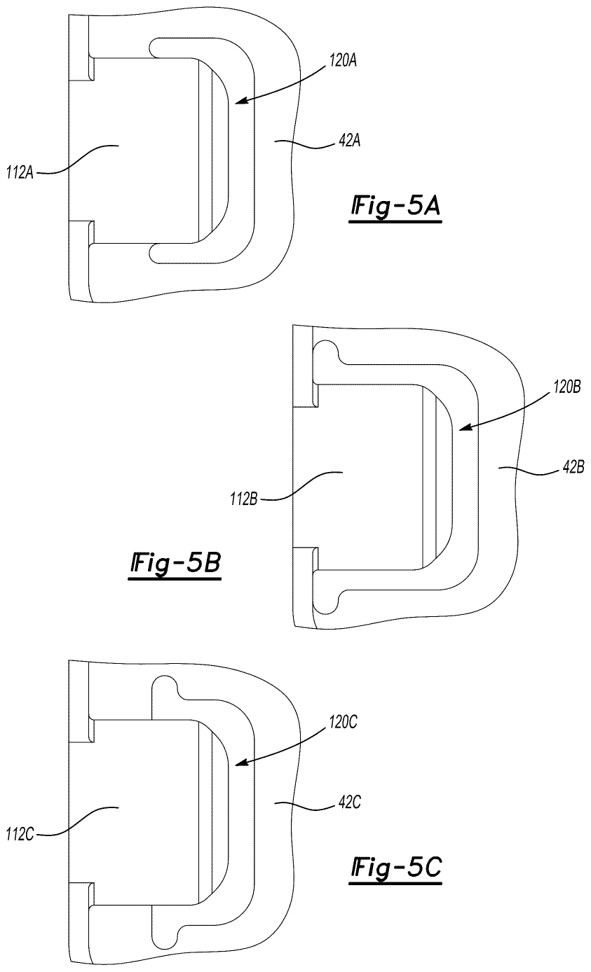

The size, profile, etc. of the relief notch 120 can vary to change flexibility of the joint 100. In FIG. 5A, an example relief notch 120A in a busbar frame 42A is used in connection with a housing 112A of another joint. The relief notch 120A is reduced in size from the relief notch 120 of FIG. 3. The relief notch 120A with the reduced open area can increase a stiffness of an associated joint when compared to the relief notch 120.

FIG. 5B shows a housing 112B used in connection with a relief notch 120B within a housing 112B. The relief notch 120B has an open area that is extended vertically upward and vertically downward when compared to the relief notch 120. Extending the relief notch 120B in this way can increase flexibility of the associated joint.

FIG. 5C shows yet another example relief notch 120C within a housing 42C. The relief notch 120C does not extend axially as far as the relief notch 120 of the FIG. 3 example or the relief notch 120B of the FIG. 5C example. The relief notch 120C can facilitate meeting desired structural, flexibility, and assembly requirements. Other profiles and sizes of the relief notch are possible and fall within the scope of this disclosure.

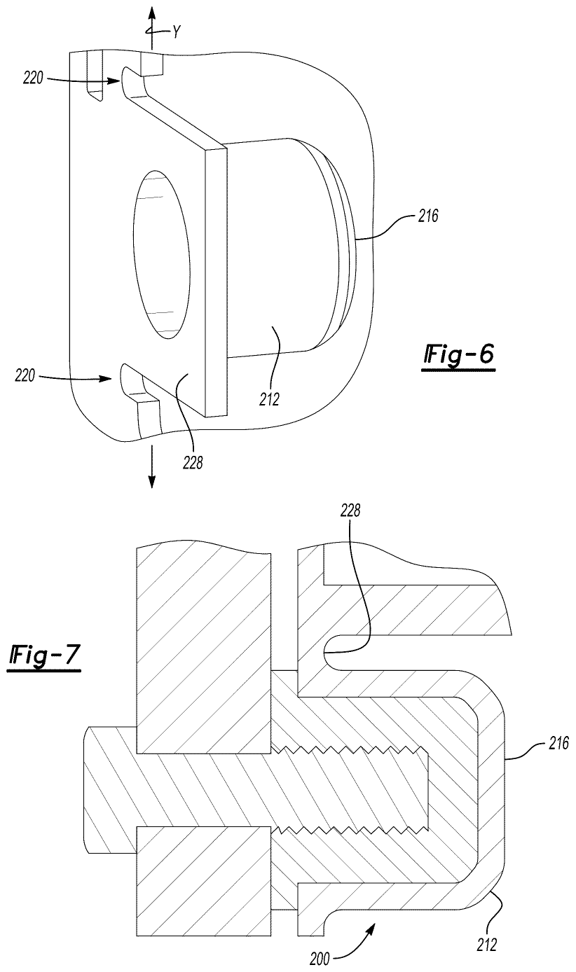

With reference now to FIGS. 6 and 7, another example joint 200 includes a housing 212 provided on a flange 228, which projects laterally outward away from an associated cell stack axis. The housing 212 provides a cup-shaped receptacle 216 that can hold an insert nut 208. The joint 200 provided by the housing 212 accommodates movement by flexing about a vertical axis Y. Relief notches 220 within the busbar frame 242 facilitate flexing of the flange 228 and the housing 212 about the vertical axis Y. The relief notches 220 open outward away from the associated cell stack axis.

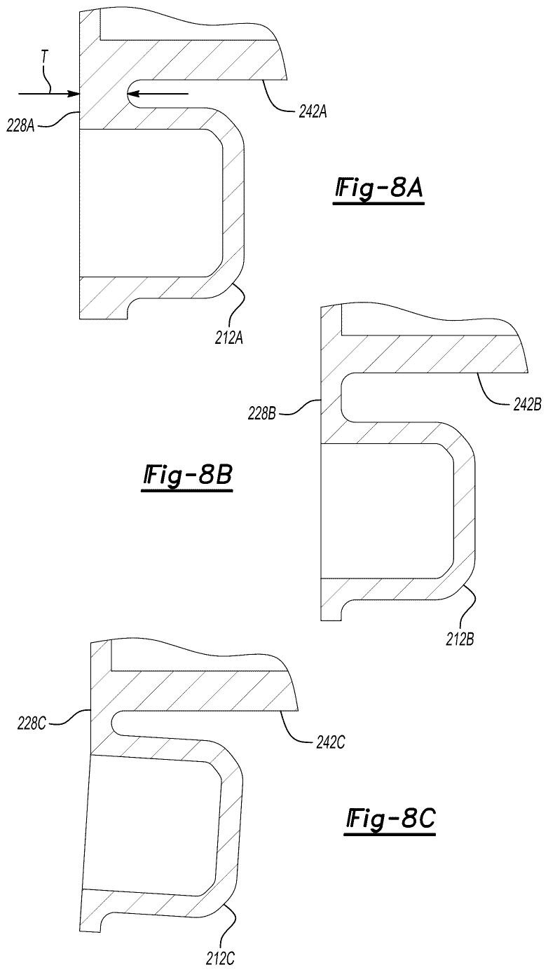

FIG. 8A shows a variation of the joint 200 shown in FIGS. 6 and 7. In the embodiment of FIG. 8A, a thickness T of the busbar frame 242A where a flange 228A with a housing 212A is increased from the flange 228 of FIG. 7. Increasing the thickness T in this area can stiffen the flange 228A and the associated joint when compared to the joint 200.

In FIG. 8B, a space between a housing 212B and other portions of the busbar frame 242B is increased from the embodiments shown in FIGS. 7 and 8A. This can increase a flexibility of the flange 228B relative to the flange 228 and the flange 228A.

In FIG. 8C, a housing 212C of a busbar frame 242C is molded such that the flange 228C with the housing 212C is tilted and angled toward an endplate. After securing a joint utilizing the housing 212C, the housing 212C tilts back to the position of the housing 212 shown in FIG. 7. The tilting of the housing 212C can facilitate contact between an endplate joined to the housing 212C. The tilting of the housing 212C substantially biases the housing 212c into contact with the endplate.

Features of the disclosed examples include joints within a battery pack that can accommodate movements of the components that the joints connect. The movements may be associated with compression of cell stack assemblies during assembly before the cell stack assembly is positioned within an enclosure in an installed position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a cell stack assembly including a plurality of battery cells disposed along a cell stack axis; and
a busbar frame joined to the cell stack assembly, the busbar frame including at least one relief notch that accommodates movement of the cell stack assembly relative to the frame.

2. The battery pack assembly of claim 1, further comprising a battery pack enclosure providing an interior, the cell stack assembly and the busbar frame housed within the interior.

3. The battery pack assembly of claim 1, wherein the busbar frame is a first busbar frame including at least one first relief notch, and further comprising a second busbar frame including at least one second relief notch that accommodates movement of the cell stack assembly along the cell stack axis, the first busbar frame on a first side of the cell stack assembly, the second busbar frame on an opposite, second side of the cell stack assembly.

4. The battery pack assembly of claim 1, further comprising a first endplate and a second endplate of the cell stack assembly, the plurality of battery cells sandwiched between the first endplate and the second endplate along the cell stack axis, the busbar frame connected to both the first endplate and the second endplate.

5. The battery pack assembly of claim 4, further comprising a battery pack enclosure that compresses together the cell stack assembly along the cell stack axis.

6. The battery pack assembly of claim 1, further comprising an endplate of the cell stack assembly and at least one joint connecting the busbar frame to the endplate, the at least one relief notch configured to accommodate movement of the at least one joint when the endplate is moved axially relative to the busbar frame.

7. The battery pack assembly of claim 6, wherein the at least one relief notch receives the at least one joint to accommodate axial movement of the endplate relative to the busbar frame.

8. The battery pack assembly of claim 6, wherein the at least one relief notch permits movement of the at least one joint to accommodate axial movement of the endplate relative to the busbar frame.

9. The battery pack assembly of claim 8, wherein the at least one relief notch opens laterally outward away from the cell stack assembly.

10. The battery pack assembly of claim 6, wherein the at least one joint comprises a mechanical fastener that engages an insert nut held in a housing.

11. The battery pack assembly of claim 10, wherein the busbar frame includes the housing.

12. The battery pack assembly of claim 11, wherein the mechanical fastener extends through an aperture in the endplate to threadably engage the insert nut held within the housing.

13. The battery pack assembly of claim 10, further comprising a flange of the busbar frame, the flange projecting laterally outward away from the cell stack assembly, the flange providing the housing.

14. The battery pack assembly of claim 6, wherein the endplate is a first endplate, the at least one joint is at least one first joint, and the at least one relief notch is at least one first relief notch, and further comprising a second endplate connected to the busbar frame through at least one second joint, and at least one second relief notch that accommodates movement of the at least one second joint when the second endplate is moved axially relative to the busbar frame.

15. A battery pack assembly, comprising:
a cell stack assembly including a plurality of battery cells disposed along a cell stack axis between a first endplate and a second endplate;
an enclosure assembly that compresses together the cell stack assembly along the cell stack axis;
a busbar frame disposed alongside the cell stack assembly;
at least one first joint connecting the busbar frame to the first endplate, the busbar frame including at least one first relief notch that permits movement of the at least one first joint when the first endplate is moved along the cell stack axis relative to the busbar frame; and
at least one second joint connecting the busbar frame to the second endplate, the busbar frame including at least one second relief notch that permits movement of the at least one first joint when the second endplate is moved along the cell stack axis relative to the busbar frame.

16. The battery pack assembly of claim 15, wherein the at least one first relief notch accommodates axial movement of the at least one first joint, wherein the at least one second relief notch accommodates axial movement of the at least one second joint.

17. The battery pack assembly of claim 15, wherein the at least one first relief notch accommodates movement of the at least one first joint, wherein the at least one second relief notch accommodates movement of the at least one second joint.

18. The battery pack assembly of claim 15, wherein the at least one first joint and the at least one second joint each comprise a cup-shaped receptacle holding an insert nut.

19. The battery pack assembly of claim 15, wherein the at least one first relief notch and the at least one second relief notch both open outward away from the cell stack assembly.
